(19) United States
(12) Patent Application Publication
(10) Pub. No.: US 2012/0256405 A1
(43) Pub. Date: Oct. 11, 2012

(54) SIDE COLLISION DETECTION SYSTEM, OCCUPANT RESTRAINT SYSTEM AND VEHICLE

(76) Inventors: YASUO ITOGA, TOKYO (JP); ATSUHIKO OIGAWA, TOKYO (JP); KAZUYA OI, TOKYO (JP); HIROO KAWAGUCHI, TOKYO (JP)

(21) Appl. No.: 13/440,072

(22) Filed: Apr. 5, 2012

(30) Foreign Application Priority Data
Apr. 7, 2011 (JP) 2011-085400

(51) Int. Cl. B60R 21/16

(52) U.S. Cl. 280/735

(57) ABSTRACT

A control device is provided with a first collision determiner for determining a side collision to a vehicle based on velocity in a direction orthogonal to the advancing direction of the vehicle, and a second collision determiner for determining a side collision to the vehicle based on a displacement amount and displacement velocity of an acceleration sensor provided in a door of the vehicle. When the vehicle is traveling at a relatively high velocity, the control device detects a side collision to the vehicle using the determination result of the first collision determiner and the determination result of the second collision determiner. In addition, when the vehicle is traveling at a low velocity or is stopped, the control device detects a side collision to the vehicle using the determination result of the first collision determiner, without using the determination result of the second collision determiner.

### CROSS-REFERENCE TO RELATED APPLICATION

This application claims the benefit of Japanese Patent Application No. 2011-85400, filed on Apr. 7, 2011, the entire disclosure of which is incorporated by reference herein.

### FIELD

This application relates generally to a side collision detection system, occupant restraint system and vehicle, and more particularly, to a side collision detection system for detecting a side collision in a vehicle, an occupant restraint system for restraining occupants, and a vehicle equipped with a side collision detection system.

### BACKGROUND

Occupant restraint devices installed in vehicles have become progressively smaller and lower cost, and at present are installed as standard equipment in most vehicles. In addition, occupant restraint devices for detecting collisions from the side of the vehicle (side collisions) and restraining occupants are becoming standard equipment in recent years.

The side collision detection system disclosed in Unexamined Japanese Patent Application Kokai Publication No. 2007-137332 includes an acceleration sensor provided in a door of the vehicle and deploys an airbag when the value of a signal output from a pressure sensor is at least as great as a threshold value. With this side collision detection system, the aforementioned threshold value changes in accordance with the locking state of the door. Through this, the airbag does not deploy in situations other than a side collision, such as when the door opens or closes.

By using the above-described side collision detection system, it is possible to prevent erroneous deployment of the airbag when opening or closing the door. However, with this side collision detection system, it is difficult to accurately decide whether or not airbag deployment is necessary in cases such as when an object moving at low velocity collides with the side of the vehicle.

### SUMMARY

In consideration of the foregoing, it is an object of the present invention to cause a restraint device to operate appropriately during a side collision.

In order to achieve the above object, a side collision detection system according to a first aspect of the present invention comprises:
a first acceleration sensor provided on a beam of a door on one side of the vehicle, for detecting acceleration in a direction orthogonal to the advancing direction of the vehicle;
a first collision determiner for detecting velocity in the direction orthogonal to the advancing direction of the vehicle based on output from the first acceleration sensor, and for determining whether or not the side collision has occurred based on the detected velocity;
a second collision determiner for detecting an amount of change in displacement of the first acceleration sensor and an extent of change with time of the displacement of the first acceleration sensor based on output from the first acceleration sensor, and for determining whether or not the side collision has occurred based on the amount of change and the extent of change with time;
a detector for detecting the side collision based on at least one out of the determination result of the first collision determiner and the determination result of the second collision determiner; and
a velocity sensor for sensing a velocity of the vehicle;
wherein the detector detects the side collision based on the determination result of the first collision determiner when the velocity of the vehicle is equal to or smaller than a threshold value.

Preferably, the threshold value is equal to or smaller than twenty kilometers per hour.

Preferably, the side collision detection system further comprises a door opened/closed sensor for sensing the opened or closed state of the door in which the first acceleration sensor is provided;
wherein the detector stops detecting the side collision when the door is in an open state and the velocity of the vehicle is not greater than a threshold value.

Preferably, the side collision detection system further comprises a second acceleration sensor provided in a different position from the first acceleration sensor on one side of the vehicle;
wherein one out of the signal from the first acceleration sensor and the signal from the second acceleration sensor is used as a safing signal, and the other is used to detect the severity of the side collision.

Preferably, the first acceleration sensor is attached to the beam via a holding member.

The occupant restraint system according to a second aspect of the present invention comprises:
the side collision detection system of the present invention; and
a restraint for restraining an occupant in the vehicle when a side collision is detected by the side collision detection system.

The vehicle according to a third aspect of the present invention is provided with the side collision detection system of the present invention.

With the present invention, a side collision is determined in accordance with vehicle velocity, and consequently it is possible to cause the restraint device to operate appropriately when a side collision occurs.

### BRIEF DESCRIPTION OF THE DRAWINGS

A more complete understanding of this application can be obtained when the following detailed description is considered in conjunction with the following drawings, in which:

FIG. 1 is a block diagram of an airbag device according to a first embodiment;

FIG. 2 is a drawing showing the state of an airbag unit after operation;

FIG. 3 is a positioning drawing for sensors comprising the airbag device;

FIG. 4 is a drawing showing acceleration sensors along with a beam;

FIG. 5 is an oblique view of a support member along with a beam;

FIG. 6 is a side view showing a support member along with a beam;

FIG. 7 is a block diagram of a control device;

FIG. 8 is a drawing showing conditions when collision determination by a collision determiner are used;

FIG. 9 is a drawing showing one example of a side collision;

FIG. 10 is a drawing showing one example of a side collision;

FIG. 11 is a drawing showing one example of a side collision;

FIG. 12 is a block diagram of an airbag device according to a second embodiment;

FIG. 13 is a block diagram of a control device;

FIG. 14 is a drawing showing conditions when collision determination by a collision determiner are used;

FIG. 15 is a block diagram of an airbag device according to a third embodiment;

FIG. 16 is a block diagram of a control device; and

FIG. 17 is a drawing schematically showing the decision flow of the control device.

### DETAILED DESCRIPTION

### First Embodiment

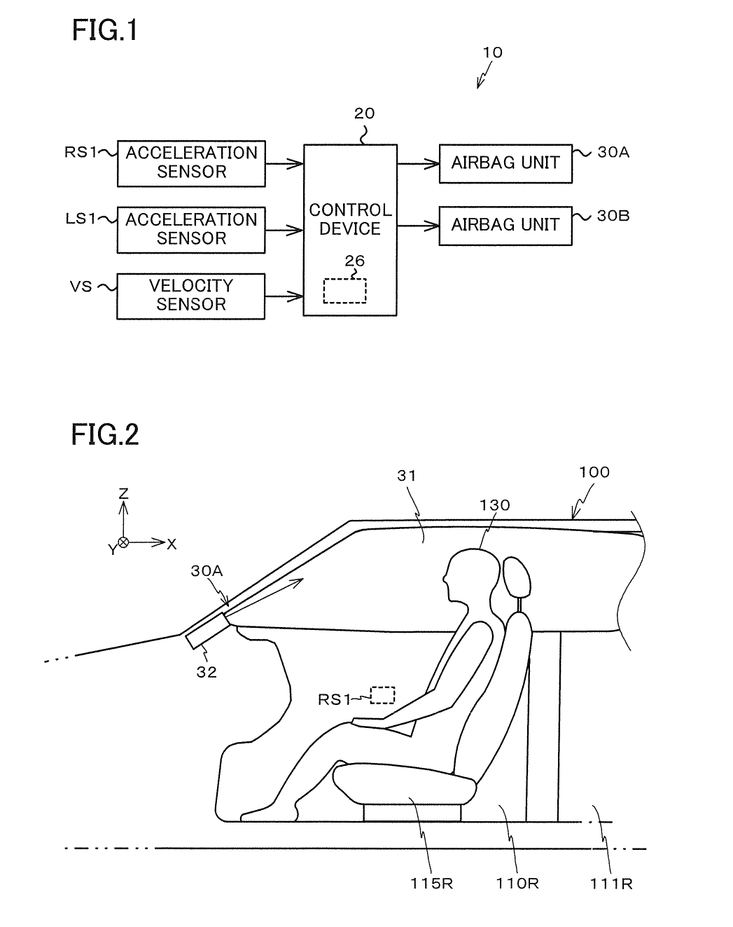

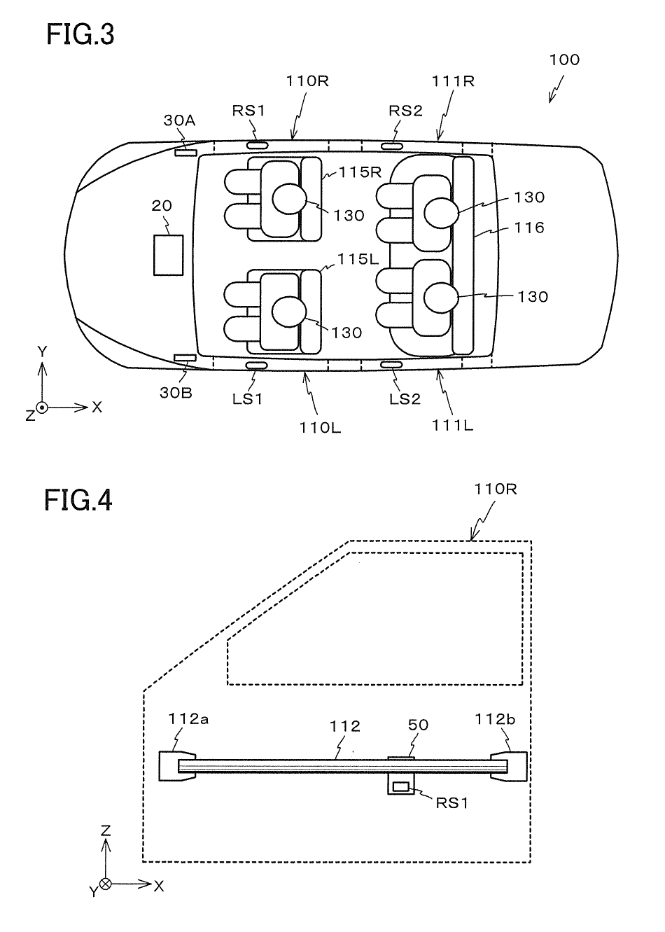

Below, the first preferred embodiment of the present invention is described with reference to the drawings. FIG. 1 is a block diagram of an airbag device 10 according to this preferred embodiment. This airbag device 10 is a device for restraining an occupant 130 seated in a front seat 115R or 115L or a rear seat 116 (see FIG. 3).

As shown in FIG. 1, the airbag device 10 has two airbag units 30A and 30B, acceleration sensors RS1 and LS1, a velocity sensor VS and a control device 20 for controlling the airbag units 30A and 30B.

FIG. 2 is a drawing showing the state of the airbag unit 30A after operation. As shown in FIG. 2, the airbag unit 30A has an airbag 31 and an inflator 32. The airbag 31 is housed in a folded state between the roof of the right side of a vehicle 100 and an inner panel thereof. Furthermore, this airbag 31 is deployed between the head of the occupant 130 and the right-side doors 11OR and 111R when gas is injected into the inside thereof by the inflator 32.

The airbag unit 30B has an airbag 31 housed in a folded state between the roof of the left side of the vehicle 100 and an inner panel, and an inflator for injecting gas into the inside of this airbag 31. The airbag 31 of the airbag unit 30B is deployed between the head of the occupant 130 and the left-side doors 110L and 111L when gas is injected into the inside thereof by the inflator 32.

The acceleration sensors RS1 and LS1 detect at least acceleration in a direction orthogonal (Y-axis direction) to the advancing direction of the vehicle 100. Furthermore, the acceleration sensors RS1 and LS1 output acceleration signals such that the values are in accordance with the detected acceleration.

FIG. 3 is a drawing showing the positioning of sensors comprising the airbag device 10. As can be seen by referring to FIG. 3, the acceleration sensor RS1 is positioned between an outer panel comprising the right-side door 110R of the vehicle 100 and an inner panel of the door 100R.

FIG. 4 is a drawing showing the acceleration sensor RS1 along with a beam 112 of the door 110R. As shown in FIG. 4, the acceleration sensor RS1 is installed on the beam 112 by means of a support member 50.

For example, the beam 112 is a cylindrical member the lengthwise direction of which is taken as the X-axis direction. This beam 112 is suspended essentially horizontally by attachment units 112a and 112b formed on the two ends thereof being anchored to the frame of the door 110R.

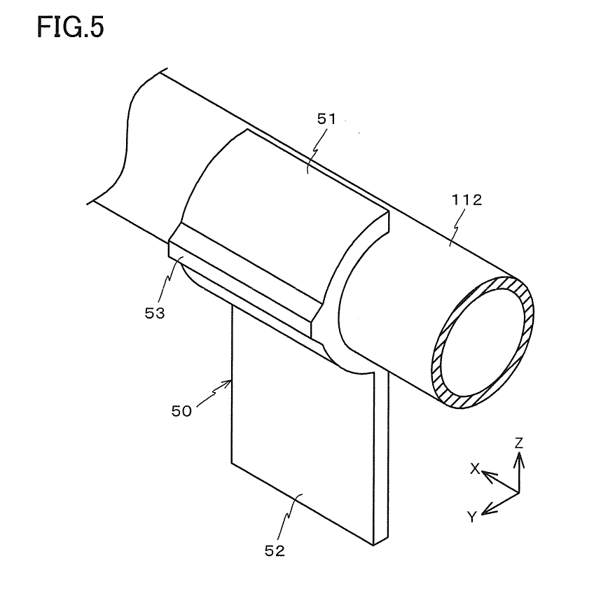

FIG. 5 is an oblique view showing the support member 50 along with the beam 112. As shown in FIG. 5, the support member 50 has an anchoring unit 51 anchored to the beam 112, and a support unit 52 extending downward (-Z direction) from the bottom edge of the support unit 52.

The anchoring unit 51 is formed so that the surface on the -Y side in contact with the beam 112 is a curved surface curving with the same curvature as the side surface of the beam 112. Furthermore, a protrusion 53 protruding in the +Y direction is formed on the surface of the anchoring unit 51 in the +Y direction.

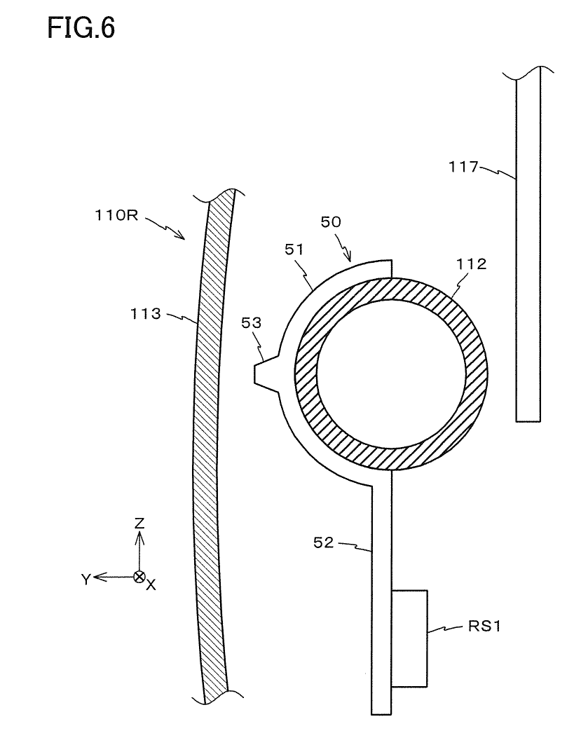

The support unit 52 is formed in a rectangular shape, the lengthwise direction thereof being the Z-axis direction. Furthermore, as shown in FIG. 6, the acceleration sensor RS1 is anchored to the -Y-side surface of the support unit 52.

The above-described support member 50 is anchored to the beam 112 such that when the -Y-side surface of the anchoring unit 51 is in contact with the side surface of the beam 112, multiple places on the anchoring unit 51 are welded to the beam 112. Through this, the acceleration sensor RS1 is supported below a window 117.

The acceleration sensor LS1 shown in FIG. 3 is installed by means of a support member 50 on the beam 112 provided in the left-side door 110L comprising the vehicle 100, similar to the acceleration sensor RS1.

Returning to FIG. 1, the velocity sensor VS is a sensor for detecting the velocity of the vehicle 100. This velocity sensor VS detects the number of rotations of an output shaft of the engine, for example. Furthermore, the velocity sensor outputs to the control device 20 a velocity signal in accordance with the detected number of rotations.

The control device 20 detects a side collision occurring in the vehicle 100 on the basis of the respective outputs from the acceleration sensors RS1 and LS1 and the velocity sensor VS. Furthermore, the control device 20 controls the airbag units 30A and 30B determines if and when the airbag units 30A and 30B should be deployed.

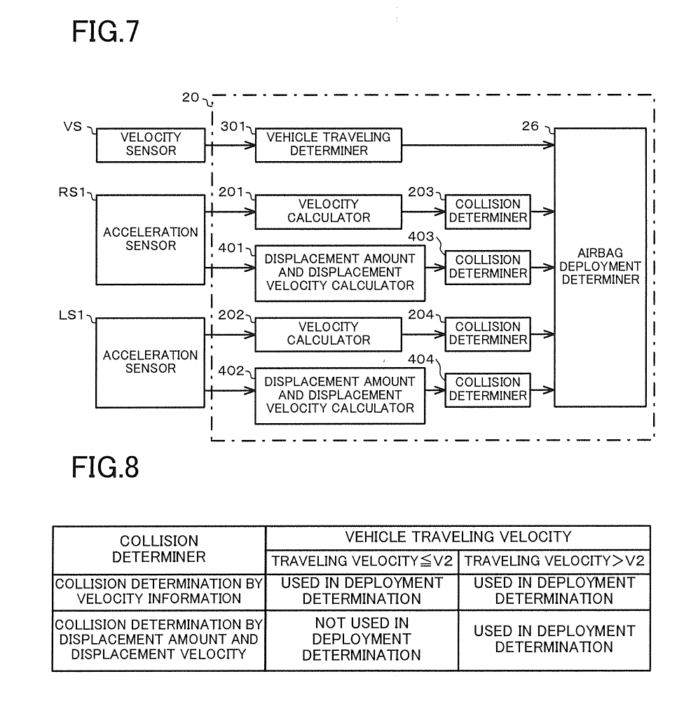

FIG. 7 is a block diagram of the control device 20. As shown in FIG. 7, the control device 20 has two velocity calculators 201 and 202, a vehicle traveling determinater 301, two displacement amount and displacement velocity calculators 401 and 402, four collision determiners 203, 204, 403 and 404, and an airbag deployment determiner 26.

The velocity calculator 201 computes the velocity of the vehicle 100 in the Y direction on the basis of the acceleration signal from the acceleration sensor RS1. Specifically, the velocity calculator 201 computes the velocity of the vehicle 100 in the Y direction by performing an integration process on the acceleration signal from the acceleration sensor RS1. Furthermore, the velocity calculator 201 outputs information (velocity information) related to the computed velocity of the vehicle 100 to the collision determiner 203.

Upon receiving the velocity information output from the velocity calculator 201, the collision determiner 203 determines the presence of a side collision on the basis of this velocity information. For example, when a side collision occurs the velocity of the vehicle 100 in the Y direction increases suddenly. Hence, the collision determiner 203 outputs a side collision determination signal to the airbag deployment determiner 26 when the velocity of the vehicle 100 in the Y direction exceeds a threshold value.

In addition, the vehicle traveling determinater 301 monitors the velocity signal from the velocity sensor VS. Furthermore, when the velocity of the vehicle 100 exceeds a threshold value V2 (for example, 12 km/h), the vehicle traveling determinater 301 outputs a traveling determination signal to the airbag deployment determiner 26.

The displacement amount and displacement velocity calculator 401 computes the displacement amount and displacement velocity of the beam 112 to which the acceleration sensor RS1 is attached, on the basis of the acceleration signal from the acceleration sensor RS1. This displacement amount and displacement velocity are equivalent to the displacement amount and displacement velocity of the acceleration sensor RS1. Specifically, the displacement amount and displacement velocity calculator 401 computes the displacement velocity of the beam 112 by performing an integration process on the acceleration signal from the acceleration sensor RS1. Next, the displacement amount and displacement velocity calculator 401 computes the displacement amount of the beam 112 by performing an integration process on the computed displacement velocity. Furthermore, the displacement amount and displacement velocity calculator 401 outputs information relating to the computed displacement velocity and displacement amount of the beam 112 (displacement velocity information and displacement amount information) to the collision determiner 403.

The collision determiner 403 receives the displacement velocity information and the displacement amount information output from the displacement amount and displacement velocity calculator 401. Furthermore, when the displacement velocity and the displacement amount of the beam 112 are each at least as great as prescribed threshold values, the collision determiner 403 outputs a side collision determination signal to the airbag deployment determiner 26.

As can be seen by referring to FIG. 1, the airbag deployment determiner 26 is positioned inside the control device 20. Furthermore, when the airbag deployment determiner 26 has determined that the airbag should be deployed, the control device 20 outputs a detection signal to the airbag unit 30A. Through this, the inflator 32 is driven and the airbag 31 is deployed to the right side of the occupant 130, as shown in FIG. 2.

The action of the control device 20 when a side collision occurs on the right side of the vehicle 100 was explained above. When a side collision occurs on the left side of the vehicle 100, the control device 20 drives the airbag unit 30B as outlined above on the basis of the acceleration signal from the acceleration sensor LS1 and the velocity signal from the velocity sensor VS.

FIG. 8 is a drawing showing conditions for using the collision determination by the collision determiner. In this preferred embodiment, when the vehicle 100 is traveling at a velocity exceeding the threshold value V2 (for example, 12 km/h), the occurrence of a side collision is detected on the basis of the collision determiners 203 and 204, which make collision determinations on the basis of the velocity information, and the collision determiners 403 and 404, which make collision determinations on the basis of the displacement amount and displacement velocity information, as can be seen by referring to FIG. 8.

In addition, in this preferred embodiment, when the vehicle 100 is traveling at a velocity below the threshold value V2, determination by the collision determiners 403 and 404, which make collision determinations on the basis of the displacement amount and displacement velocity information, is not used.

Consequently, the severity of the side collision is detected on the basis of the determination results of the collision determiners 203 and 204, which make collision determinations on the basis of the velocity information, and the airbag is deployed on the basis of this detection result. Through this, deployment of the airbag erroneously when the vehicle is stopped does not occur, and it is possible to appropriately restrain the occupant 130 when a side collision ultimately occurs.

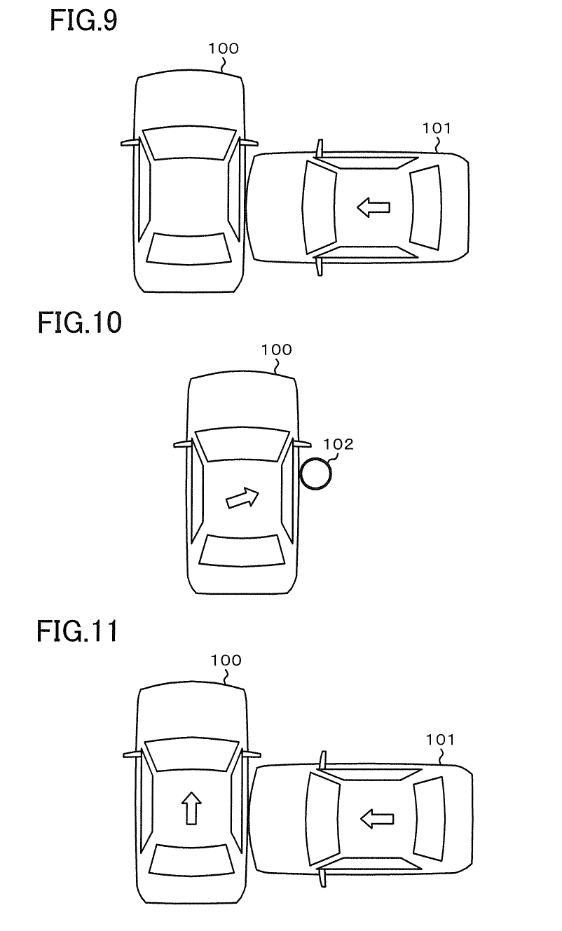

In the airbag device 10 according to this preferred embodiment, when the vehicle 100 is stopped, cases in which deployment of the airbag becomes necessary due to a side collision are times when a vehicle 101 collides with the side of the vehicle 100 for example, as can be seen by referring to FIG. 9.

In addition, in the airbag device 10 according to this preferred embodiment, when the vehicle 100 is traveling, cases in which deployment of the airbag is necessary due to a side collision are times when the vehicle collides from the side with an object 102 such as a pole, as can be seen by referring to FIG. 10, or when another vehicle 101 collides with the side of the traveling vehicle 100, as can be seen by referring to FIG. 11.

With the airbag device 10 according to this preferred embodiment, when another vehicle 101 collides with the side of the vehicle 100 while the vehicle 100 is stopped, the collision determination is made primarily based on the output from the collision determiners 203 and 204. Furthermore, when the traveling vehicle 100 collides from the side with a stationary object such as the object 102, the collision determination is made primarily based on the output from the collision determiners 403 and 404.

When the vehicle 100 collides with a stationary object such as the object 102 while traveling at low velocity (for example, 12 km/h), there is a large possibility that this will not be a collision in which the airbag should be deployed. Accordingly, when the vehicle 100 is traveling at a low velocity less than the threshold value V2, by making a determination as to whether or not to deploy the airbag without using the outputs of the collision determiners 403 and 404, the airbag is not deployed unnecessarily. In addition, when a side collision occurs, it is possible to appropriately deploy the airbag.

The threshold value V2 is preferably set in accordance with the type of vehicle. However, the threshold value V2 is preferably set at an arbitrary value not greater than 20 km/h so as to be a velocity at which no major injuries are inflicted on the occupant arising from a side collision with the object 102 and/or the like.

In addition, with this preferred embodiment, the acceleration sensors RS1 and LS1 for detecting side collisions occurring in the vehicle 100 are supported below the beam 112 by the support unit 52 of the support member 50. Thus, even when a force caused by a collision with the beam 112 occurs, this force is conveyed to the acceleration sensors RS1 and LS1 after being dampened by the support unit 52 of the support member.

Through this, even if the beam 112 moves at a velocity exceeding the rated input of the acceleration sensors RS1 and LS1, the acceleration of the acceleration sensors RS1 and LS1 is kept to no greater than the rated value. Accordingly, an acceleration at least as great as the rated value is not input to the acceleration sensors RS1 and LS1, so it is possible to avoid signals from the detection devices becoming saturated. Hence, it is possible to detect the occurrence of side collisions more accurately.

### Second Embodiment

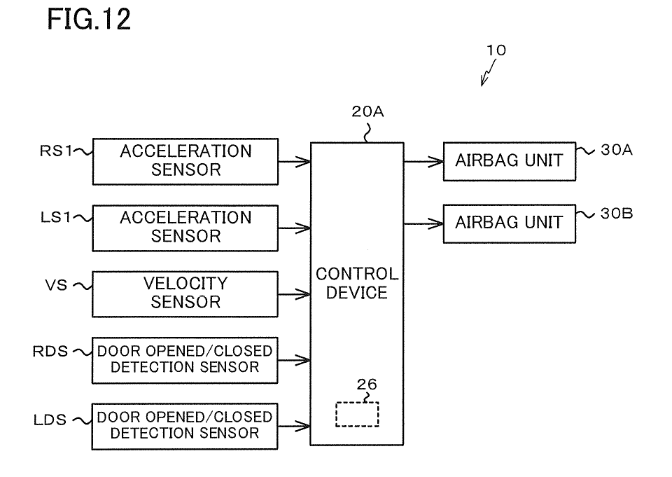

Next, a second preferred embodiment of the present invention is described with reference to FIGS. 12 through 14. Compositions that are the same as or equivalent to those of the first preferred embodiment will use the same symbols and explanation of such will be abbreviated or omitted here.

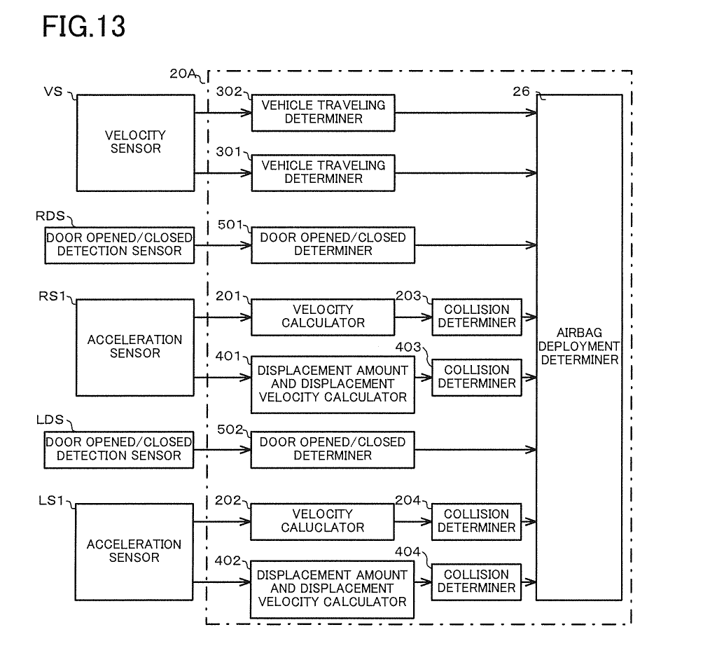

The airbag device 10 according to this preferred embodiment differs from the airbag device 10 according to the first preferred embodiment in having door opened/closed detection sensors RDS and LDS, door opened/closed determiners 501 and 502, and a vehicle traveling determiner 302, as can be seen by referring to FIGS. 12 and 13. The door opened/closed detection sensors RDS and LDS detect the open or closed state of the doors 11OR and 110L to which the acceleration sensors RS1 and LS1 are attached.

FIG. 13 is a block diagram of a control device 20A according to this preferred embodiment. This control device 20A has vehicle traveling determiners 301 and 302, velocity calculators 201 and 202, displacement amount and displacement velocity calculators 401 and 402, collision determiners 203, 204, 403 and 404, door opened/closed determiners 501 and 502, and an airbag deployment determiner 26.

The vehicle traveling determiner 302 determines whether or not the vehicle 100 is stopped on the basis of signals from the velocity sensor VS. This determination is made by whether or not the vehicle 100 is traveling at a velocity exceeding a threshold value V1 (for example, 3 km/h). Furthermore, when the vehicle 100 is traveling at a velocity exceeding the threshold value V1, the vehicle traveling determiner 302 outputs a traveling detection signal to the airbag deployment determiner 26.

The door opened/closed determiners 501 and 502 determine whether or not the doors of the vehicle 100 are open, on the basis of signals from the door opened/closed detection sensors RDS and LDS. Furthermore, when it is determined that the doors of the vehicle 100 are closed, the door opened/closed determiners 501 and 502 output determination signal indicating that the doors are closed to the airbag deployment determiner 26.

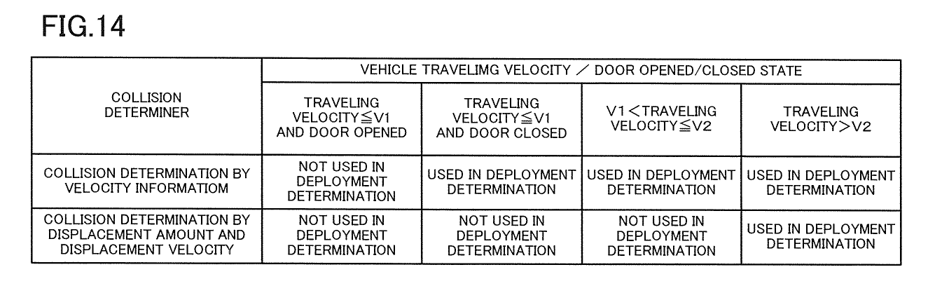

FIG. 14 is a drawing showing the conditions for using collision determination by the collision determiners. With this preferred embodiment, when the vehicle 100 is traveling at a velocity exceeding a threshold value V2, if a side collision occurs the occurrence of the side collision is detected based on the determination results of the collision determiners 203 and 204, which make collision determinations based on the velocity information, and the determination results of the collision determiners 403 and 404, which make collision determinations on the basis of the displacement amount and displacement velocity information, as can be seen by referring to FIG. 14.

With this preferred embodiment, if a side collision occurs when the vehicle 100 is traveling at a velocity not greater than the threshold value V2 (when the velocity is not greater than the threshold value V2 but is larger than the threshold value V1), determinations about whether or not to deploy the airbag are made without using output from the collision determiners 403 and 404, which make collision determinations based on the displacement amount and displacement velocity information, as can be seen by referring to FIG. 14.

In other words, determinations of whether or not to deploy the airbag are made based on determination results from the collision determiners 203 and 204, which make collision determinations based on the velocity information.

In addition, with this preferred embodiment, when the vehicle 100 is operating at a velocity not greater than the threshold value V1 (when the vehicle is stopped), if a side collision occurs when the doors are closed, a collision determination is made based on the velocity information, as can be seen by referring to FIG. 14.

With this preferred embodiment, side collisions are determined based on determination results from the collision determiners 203 and 204 that make collision determinations based on velocity, and from the collision determiners 403 and 404 that make collision determinations based on the displacement amount and displacement velocity information. Furthermore, when the vehicle 100 is traveling at a velocity not greater than the threshold value V1 and the doors are closed, the severity of the side collision is detected based on the output from the collision determiners 203 and 204 that make collision determinations based on velocity information. Furthermore, whether or not to deploy the airbag is determined based on these detection results.

In the airbag device 10 according to this preferred embodiment, when the vehicle 100 is stopped, cases in which deployment of the airbag becomes necessary due to a side collision are times when a vehicle 101 collides with the side of the vehicle 100 for example, as can be seen by referring to FIG. 9.

In addition, in the airbag device 10 according to this preferred embodiment, when the vehicle 100 is traveling, cases in which deployment of the airbag is necessary due to a side collision are times when the vehicle collides from the side with an stationary object 102 such as a pole, as can be seen by referring to FIG. 10, or when another vehicle 101 collides with the side of the traveling vehicle 100, as can be seen by referring to FIG. 11.

With the airbag 10 according to this preferred embodiment, when another vehicle 101 collides with the side of the vehicle 100 while the vehicle 100 is stopped, the collision determination is made primarily based on the output from the collision determiners 203 and 204. Furthermore, when the traveling vehicle 100 collides from the side with a stationary object such as the unmoving object 102, the collision determination is made primarily based on the output from the collision determiners 403 and 404.

When the vehicle 100 collides with a stationary object such as the object 102 while traveling at low velocity (for example, 12 km/h), it is likely that this will not be a collision in which the airbag should be deployed. Accordingly, when the vehicle 100 is traveling at a low velocity less than the threshold value V2, by making a determination as to whether or not to deploy the airbag without using the outputs of the collision determiners 403 and 404, the airbag is not deployed unnecessarily. When a side collision does occur, the airbag is appropriately deployed.

When, for example, acceleration is detected while a door is open, the control device 20A cannot determine only by means of the acceleration sensors installed in the door whether or not the detection results are a side collision. In addition, when a door is open the control device 20A cannot determine whether or not the detection results are caused by a collision of that door with a structure (for example, the side of a building) next to the vehicle 100. With this preferred embodiment, when the vehicle 100 has a velocity not greater than the threshold value V1 (when the vehicle is stopped), if a door is open the determination of whether or not a side collision has occurred is not made based on outputs from the acceleration sensors RS1 and LS1 provided in the door. Consequently, the airbag is not deployed unnecessarily. In addition, when a side collision occurs, it is possible to appropriately deploy the airbag.

In addition, with this preferred embodiment, when a side collision occurs while the vehicle 100 is traveling at a velocity in excess of the threshold value V2 (for example, 12 km/h), the displacement velocity or displacement amount of the beam 112 is detected based on acceleration signals from the acceleration sensors RS1 and RS2, as can be seen by referring to FIG. 14. Furthermore, the occurrence of a side collision is detected based on this displacement velocity and displacement amount. Accordingly, it is possible to deploy the airbag 31 with appropriate timing when a side collision occurs while the vehicle 100 is traveling normally.

### Third Embodiment

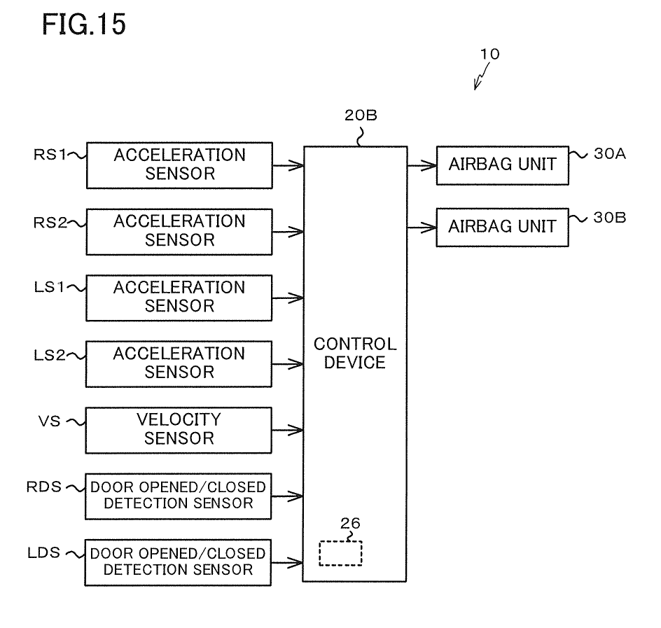

Next, a third preferred embodiment of the present invention will be explained with reference to FIGS. 15 to 17. Compositions that are the same as or equivalent to those of the above-described preferred embodiments will use the same symbols and explanation of such will be abbreviated or omitted here.

FIG. 15 is a block diagram of the airbag device 10 according to this preferred embodiment. The airbag device 10 according to this preferred embodiment differs from the airbag device 10 according to the above-described embodiments in having acceleration sensors RS2 and LS2 installed in the doors 111R and 111L of the vehicle 100.

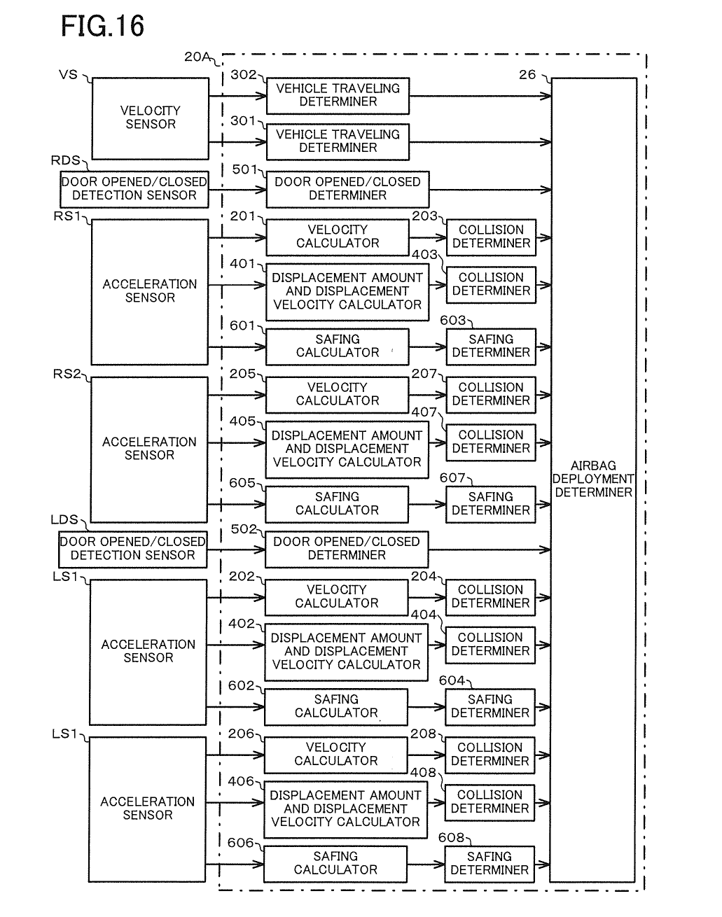

FIG. 16 is a block diagram of a control device 20B according to this preferred embodiment. This control device 20B has vehicle traveling determiners 301 and 302; velocity calculators 201, 202, 205 and 206; displacement amount and displacement velocity calculators 401, 402, 405 and 406; collision determiners 203, 204, 207, 208, 403, 404, 407 and 408; door opened/closed determiners 501 and 502; safing calculators 601, 602, 605 and 606; safing determiners 603, 604, 607, and 608; and an airbag deployment determiner 26.

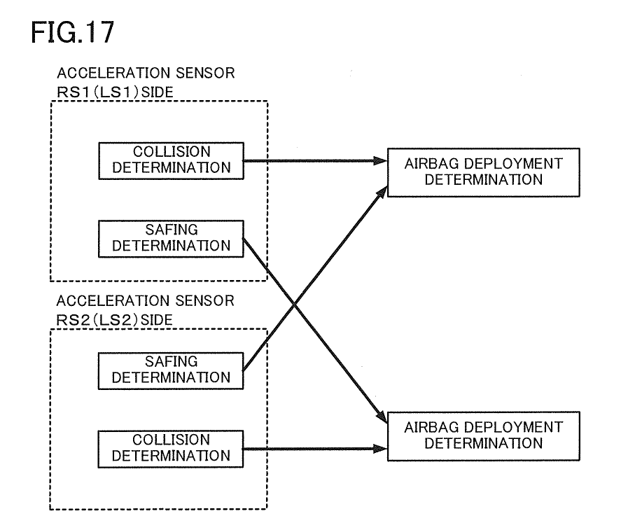

FIG. 17 is a drawing schematically showing the determination flow of the control device 20B. With this preferred embodiment, collision determination results are output based on the traveling velocity of the vehicle 100, the door opened/closed state and the acceleration sensor RS1 (LS1), as can be seen by referring to FIGS. 16 and 17. In addition, at the same time safing determination results indicating whether or not there was a side collision to the vehicle 100 are output from the safing determiner 607 (608) based on signals output from the acceleration sensor RS2 (LS2). Furthermore, when the result from both of these results is that a side collision has occurred, the control device 20B determines this is a collision for which the airbag should be deployed. Consequently, it is possible to deploy the airbag 31 with appropriate timing.

In addition, with this preferred embodiment, collision determination results are output based on the traveling velocity of the vehicle 100, the door opened/closed state and the acceleration sensor RS2 (LS2), as can be seen by referring to FIGS. 16 and 17. In addition, at the same time safing determination results indicating whether or not there was a side collision to the vehicle 100 are output from the safing determiner 603 (604) based on signals output from the acceleration sensor RS1 (LS1). Furthermore, when both of these results indicate a side collision has occurred, the control device 20B determines that this is a collision for which the airbag should be deployed. Consequently, it is possible to deploy the airbag 31 with appropriate timing.

The preferred embodiments of the present invention are described above, but the present invention is not limited by the above-described preferred embodiments. For example, the control device 20 according to the above-described preferred embodiments may be comprised of hardware, or may be a computer or microcomputer comprised including a CPU (Central Processing Unit), main memory, auxiliary memory and/or the like.

In addition, in the above-described preferred embodiments, the velocity information of the vehicle 100 was obtained based on a velocity signal from the velocity sensor, but the means of acquiring the velocity information of the vehicle 100 is not limited to this. For example, the velocity information of the vehicle 100 may be obtained by calculating the acceleration in the advancing direction using an acceleration sensor and performing an integration process on this calculated result. In addition, the velocity information of the vehicle may be obtained using radar and/or the like.

Having described and illustrated the principles of this application by reference to more than one preferred embodiment, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A side collision detection system for detecting a side collision to a vehicle, said system comprising:
a first acceleration sensor provided on a beam of a door on one side of the vehicle, for detecting acceleration in a direction orthogonal to the advancing direction of the vehicle;
a first collision determiner for detecting velocity in the direction orthogonal to the advancing direction of the vehicle based on output from the first acceleration sensor, and for determining whether or not the side collision has occurred based on the detected velocity;
a second collision determiner for detecting an amount of change in displacement of the first acceleration sensor and an extent of change with time of the displacement of the first acceleration sensor based on output from the first acceleration sensor, and for determining whether or not the side collision has occurred based on the amount of change and the extent of change with time;
a detector for detecting the side collision based on at least one out of the determination result of the first collision determiner and the determination result of the second collision determiner; and
a velocity sensor for sensing a velocity of the vehicle;
wherein the detector detects the side collision based on the determination result of the first collision determiner when the velocity of the vehicle is equal to or smaller than a threshold value.

2. The side collision detection system of claim 1, wherein the threshold value is equal to or smaller than twenty kilometers per hour.

3. The side collision detection system of claim 1, further comprising a door opened/closed sensor for sensing the opened or closed state of the door in which the first acceleration sensor is provided;
wherein the detector stops detecting the side collision when the door is in an open state and the velocity of the vehicle is not greater than a threshold value.

4. The side collision detection system of claim 1, further comprising a second acceleration sensor provided in a different position from the first acceleration sensor on one side of the vehicle;
wherein one out of the signal from the first acceleration sensor and the signal from the second acceleration sensor is used as a safing signal, and the other is used to detect the severity of the side collision.

5. The side collision detection system of claim 1, wherein the first acceleration sensor is attached to the beam via a holding member.

6. An occupant restraint system, comprising:
the collision detection system of claim 1; and
a restraint for restraining an occupant in the vehicle when a side collision is detected by the side collision detection system.

7. A vehicle provided with the side collision detection system of claim 1.
